(19) United States
(12) Patent Application Publication
(10) Pub. No.: US 2021/0324220 A1
(43) Pub. Date: Oct. 21, 2021

(54) PRINT RECEPTIVE TOPCOAT

(71) Applicant: Avery Dennison Corporation, Glendale, CA (US)

(72) Inventors: Dhananjay PATIL, Thane West (IN); Virendrasing J. PATIL, Jalgaon (IN)

(21) Appl. No.: 17/272,562

(22) PCT Filed: Aug. 22, 2019
(86) PCT No.: PCT/US2019/047674

§ 371 Date: Mar. 1, 2021

(30) Foreign Application Priority Data
Aug. 31, 2018 (IN) 201811032689

(51) Int. Cl. C09D 11/54; C09D 11/107; C09D 11/033; C09J 7/29; C09J 7/38

(52) U.S. Cl. CPC C09D 11/54; C09D 11/107; C09D 11/033; C09J 7/29; C09J 7/38; C09J 2203/334; C09J 2427/006; C09J 2301/162; C09J 2400/283; C09J 2433/006; C09J 2423/046; C09J 2423/106; C09J 2467/006; C09J 2301/302

(57) ABSTRACT

The present disclosure relates to transparent flame-retardant coating compositions and labels including layers comprising the same. The coating composition comprises a high-hydroxyl value polymer, a crosslinker, and a flame-retardant additive comprising a phosphinate compound. The coating composition may be coated on a substrate such as a label. The coating composition forms a layer that advantageously has flame-retardant properties and is optically clear.

### PRIORITY CLAIM

This application claims priority to Indian Patent Application No. 201811032689 filed Aug. 31, 2018, the entire contents and disclosure of which are incorporated herein.

### FIELD OF THE INVENTION

The present invention relates generally to a topcoat comprising a cationic acrylic polymer, which is optionally crosslinked. The topcoat, may accept print from numerous individual printing platforms and may have desirable ink anchorage for conventional and low migration inks.

### BACKGROUND OF THE INVENTION

Print receptive topcoats are used in various applications, including topcoats for films and papers. Depending on the use of the topcoat, differing printing techniques are used. Non-limiting examples of these techniques include dry toner, UV flexo, WB (water-based) flexo, offset, laser, and HP Indigo. Because of the compositions and methods used for these various printing techniques, the topcoat must often be tailored to maximize receptiveness of the topcoat for the specific printing technique, leading to increased manufacturing costs. Additionally, known topcoats suffer from additional problems with adhesion, antiblocking, and processing.

Various formulations of printable or print receptive topcoats, e.g., for polyolefin and/or other filmic or face materials, are generally known in the art. Although many topcoats are available, they are printable on limited platforms, have adhesion on limited films, have acceptable ink adhesion for only conventional inks, and therefore they are not considered “universal” topcoats. Additionally, many existing topcoats demand modification to achieve desired performance of processing requirements. These modifications may include external additives, cross-linkers, or other modifiers. For example, U.S. Pub. No. 2004/0197572 discloses a coated sheet in which a coating composition comprises a urethane polymer component, an acrylic polymer component, and a plurality of cross-linkers.

WO 02/38382 discloses a sheet like substrate comprising a substantially non-polar material having coated onto at least one side thereon an anchor coating to aid subsequent coating thereon of a polar coating and/or layer. The anchor coating comprises (a) a polymer comprising an optionally substituted α, β carboxylic acid optionally of high acid value preferably the polymer having a low T_{g}; (b) a polymer comprising an optionally unsubstituted α, β carboxylic acid optionally of low acid value preferably the polymer having a high T_{g}; and (c) a crosslinker, preferably added after a period of time to a mixture of polymers (a) and (b) to crosslink the resultant coating composition and increase the T_{g} thereof.

U.S. Pat. No. 6,866,383 discloses an ink-receptive composition, comprising: (a) a filler; (b) a binder, comprising a homopolymer, copolymer or terpolymer of a vinyl alcohol, a vinyl acetate, a vinyl chloride or combinations of two or more thereof; (c) at least one quaternary ammonium polymer and (d) at least one hydroxyalkylated polyalkyleneimine, wherein the composition, when coated on a substrate, forms an ink-receptive coating which accepts ink loading greater than about 300%.

US Pub. No. 2007/116905 discloses a thermal transfer image receiving sheet comprising: a substrate sheet supporting an image receiving resinous layer for receiving a transferred image, wherein the image receiving layer is formed by drying an aqueous coating composition. The aqueous coating composition comprises (a) at least one water dispersible aliphatic polyether-polyurethane resin, and at least one water dispersible aliphatic polyester-polyurethane resin, or (b) at least one water dispersible aliphatic polyether-polyurethane resin, a silica dispersion, and an anionic aqueous emulsion of wax; and an aqueous crosslinking agent.

U.S. Pat. No. 9,061,536 discloses a printable or print receptive topcoating for a face material, said topcoating comprising a polyether urethane; a polyurethane acrylate; a crosslinker, wherein the crosslinker comprises an amount in a range of from about 2 parts to about 15 parts based on 100 parts total solids; and an anti-blocking additive, wherein the polyurethane is a water dispersible polyurethane.

None of the above-disclosed references, however, provide for topcoats that are able to accept and retain print from various printing techniques, while maintaining adhesiveness to the underlying substrate. In view of the foregoing drawbacks, the need exists for a cost effective topcoat that can accept and retain print from various printing techniques and inks while maintaining adhesiveness to the underlying substrate.

### SUMMARY OF THE INVENTION

In some embodiments, the disclosure is directed to topcoat solution consisting essentially of: a cationic acrylic polymer and an optional crosslinker, wherein when present, the crosslinker is present in an amount of at least 1.5%, based on the total weight of the topcoat solution. The cationic acrylic polymer may be present in an amount from 10 to 98.5 parts by weight, based on a total of 100 parts by weight. The cationic acrylic polymer may comprise an aliphatic cationic acrylate, an aromatic cationic acrylate, an aliphatic cationic methacrylate, an aromatic cationic methacrylate, or combinations thereof. The topcoat solution may contain a single cationic acrylic polymer. In some aspects, the crosslinker is present from 1.5 to 10 wt. %, based on a total of 100 parts by weight. The topcoat solution may further comprise water. The water may be present from 0.1 to 75 wt. %. The cationic acrylic polymer may be a cationic acrylic polymer dispersion. The cationic acrylic dispersion may have a solids content from 25 to 55%. The cationic acrylic polymer may have a pH from 4 to 6. The crosslinker may be an aziridine, isocyanate, or epoxy crosslinker. The cationic acrylic polymer may have hydroxyl functionality.

In some embodiments, the disclosure is directed to a coated substrate comprising: (a) a substrate and (b) a topcoat consisting essentially of a cationic acrylic polymer and an optional crosslinker, wherein when present, the crosslinker is present in an amount of at least 1.5%, based on the total weight of the topcoat solution. The cationic acrylic polymer may be present in an amount from 10 to 98.5 parts by weight, based on a total of 100 parts by weight. The cationic acrylic polymer may comprise an aliphatic cationic acrylate, an aromatic cationic acrylate, an aliphatic cationic methacrylate, an aromatic cationic methacrylate, or combinations thereof. The topcoat solution may contain a single cationic acrylic polymer. In some aspects, the crosslinker is present from 1.5 to 10 wt. %, based on a total of 100 parts by weight. The topcoat solution may further comprise water. The water may be present from 0.1 to 75 wt. %. The cationic acrylic polymer may be a cationic acrylic polymer dispersion. The cationic acrylic dispersion may have a solids content from 25 to 55%. The cationic acrylic polymer may have a pH from 4 to 6. The crosslinker may be an aziridine, isocyanate, or epoxy crosslinker. The cationic acrylic polymer may have hydroxyl functionality. The substrate may be a paper or a film. An ink may be printed onto the topcoat. The ink may be a conventional ink and/or a low migration ink. The topcoat may be coated onto the substrate in a coat weight from 0.1 gsm to 1.5 gsm.

In some embodiments, the disclosure is directed to a label comprising: (a) a substrate; and (b) a topcoat consisting essentially of a cationic acrylic polymer and an optional crosslinker, wherein when present, the crosslinker is present in an amount of at least 1.5%, based on the total weight of the topcoat solution, wherein the topcoat is in contact with the substrate. The topcoat may be coated onto the substrate in a coat weight from 0.1 gsm to 1.5 gsm. The substrate may comprise a film and wherein a top surface of the film is in contact with the topcoat. The film may comprise biaxially oriented polypropylene (BOPP), polyethylene terephthalate (PET), polyethylene (PE), and/or polyvinyl chloride (PVC). The substrate may further comprise an adhesive layer, wherein a top surface of the adhesive layer is in contact with a bottom surface of the film. The substrate may further comprise a release liner in contact with a bottom surface of the adhesive layer. The cationic acrylic polymer may comprise an aliphatic cationic acrylate, an aromatic cationic acrylate, an aliphatic cationic methacrylate, an aromatic cationic methacrylate, or combinations thereof. The adhesive layer may comprise a pressure sensitive adhesive. The cationic acrylic polymer may have a pH from 4 to 6. The crosslinker may be an aziridine, isocyanate, or epoxy crosslinker.

In some embodiments, the disclosure is directed to a method of forming a topcoat comprising: (i) providing a cationic acrylic polymer and an optional crosslinker; (ii) optionally crosslinking the cationic acrylic polymer, (iii) coating the cationic acrylic polymer onto a substrate; and (vii) drying the topcoat on the substrate to form a coated substrate. The cationic acrylic polymer may be present in an amount from 10 to 98.5 parts by weight, based on a total of 100 parts by weight of the topcoat. The cationic acrylic polymer may comprise an aliphatic cationic acrylate, an aromatic cationic acrylate, an aliphatic cationic methacrylate, an aromatic cationic methacrylate, or combinations thereof. The cationic acrylic polymer may be a single cationic acrylic polymer. The crosslinker may be present from 1.5 to 10 wt. %, based on a total of 100 parts by weight of the components of (i). The cationic acrylic polymer may be in a water solution. The water may be present from 0.1 to 75 wt. %, based on the total weight of the components of (i). The cationic acrylic polymer may be a cationic acrylic polymer dispersion. The cationic acrylic dispersion may have a solids content from 25 to 55%. The cationic acrylic polymer may have a pH from 4 to 6. The crosslinker may be an aziridine, isocyanate, or epoxy crosslinker. The cationic acrylic polymer may have hydroxyl functionality. In some aspects, when the substrate comprises polyethylene and/or polyethylene terephthalate, no crosslinker is used. In further aspects, when the substrate comprises polypropylene, crosslinker is used.

In some embodiments, the disclosure is directed to a coated substrate, wherein the substrate comprises polyethylene, polyethylene terephthalate, and/or polypropylene, and wherein the substrate is coated with a topcoat consisting essentially of cationic acrylic polymer. The cationic acrylic polymer may comprise an aliphatic cationic acrylate, an aromatic cationic acrylate, an aliphatic cationic methacrylate, an aromatic cationic methacrylate, or combinations thereof. The cationic acrylic polymer may be a single cationic acrylic polymer. The cationic acrylic polymer may have hydroxyl functionality. The cationic acrylic polymer may have a pH from 4 to 6. The topcoat may be coated onto the substrate in a coat weight from 0.1 gsm to 1.5 gsm.

In some embodiments, the disclosure is directed to a coated polypropylene substrate, wherein the substrate is coated with a topcoat consisting essentially of a crosslinked cationic acrylic polymer. The cationic acrylic polymer may comprise an aliphatic cationic acrylate, an aromatic cationic acrylate, an aliphatic cationic methacrylate, an aromatic cationic methacrylate, or combinations thereof. The cationic acrylic polymer may be a single cationic acrylic polymer. The cationic acrylic polymer may have hydroxyl functionality. The cationic acrylic polymer may have a pH from 4 to 6. The crosslinker may be an aziridine, isocyanate, or epoxy crosslinker. The topcoat may be coated onto the substrate in a coat weight from 0.1 gsm to 1.5 gsm.

### DETAILED DESCRIPTION OF THE INVENTION

A topcoat that is able to receive and retain print from a variety of printing techniques may be useful as a universal topcoat that may be applied to various labels and papers. The topcoats described herein adhere to most of the commonly used packaging and printing films, such as polyester, biaxially oriented polypropylene, polyethylene, polypropylene, polyvinyl chloride, nylon, and the like, which retain print from various printing platforms, such as UV flexo, water based flexo, thermal transfer (TT) UV inkjet, cold foil, hot foil, letterpress, serigraphy, HP Indigo, offset, laser (cold as well as hot laser),and toner inks (including liquid and dry toner). Such inks are generally conventional inks, as defined herein. It has now been discovered that the utilization of a cationic acrylic polymer in combination with a crosslinker in a specific amount provides for unexpected performance properties of the resultant topcoat. The topcoat may be clear or opaque (having a white face). For example, the use of a topcoat comprising a crosslinked cationic acrylic polymer has been found to improve ink retention on the topcoat for conventional inks while also having sufficient adhesion of the topcoat to the film or paper to which it has been applied. The resultant topcoat may be coated onto polymer layers, such as films, or papers which are used in a variety of fields and may be referred to as a universal topcoat.

As explained herein, a problem in the art relates to inks or coatings failing to adhere to a substrate. Adhesion depends, to a great degree, on the surface energy of substrate or wet topcoat. Surface energy is related to the degree to which the surface can be wetted. Wetting indicates that the liquid, such as ink, will spread on the substrate surface. For ink to adhere to the surface, the ink must demonstrate good wetting, which occurs when the ink has a lower surface energy than the substrate. Thus, the substrate should have a greater surface energy than the print that it is intended to receive. For example, UV inks may generally have surface tensions (referred to as surface tension, because the ink is in liquid form) from 23 to 35 millinewtons per meter (mN/m). Solvent based inks, especially alcohol based inks, have a lower surface tension than UV inks. Water has a surface tension of about 72 mN/m and so water based inks generally have a greater surface tension, than UV based inks.

Although decreasing the surface tension of the print media is possible, it is more desirable to increase the surface energy of the substrate. One known method of achieving such an increase is a corona treatment, also referred to as air plasma treatment. Corona treatment, however, diminishes over time and may have to be repeated if the substrate is stored. The present inventors have surprisingly and unexpectedly discovered that the print adherence and retention may be improved by applying a topcoat comprising a cationic acrylic polymer and an optional crosslinker to the substrate. In some aspects, the topcoat consists essentially of a cationic acrylic polymer and an optional crosslinker, e.g., contains no other polymeric components and any additives that are included do not substantially affect ink anchorage. Advantageously, the surface energy of the topcoat comprising the optionally crosslinked cationic acrylic polymer does not diminish over time, while still achieving good adhesion of the topcoat to the substrate. Adhesion of the topcoat to the substrate may be tested by using 3M 810 and 3M 610 tapes. The tape is applied to the dried topcoat. The tape is left on the topcoat for 30 seconds then the tape is pulled off as fast as possible at a 180° angle to check the adhesion of the topcoat to the substrate. The substrate may then be viewed using infrared spectroscopy to check for the presence of the topcoat on the substrate. When topcoat is present on the substrate, the topcoat is said to have excellent adhesion to the substrate. The substrate may then be viewed using infrared spectroscopy to check for the presence of the topcoat on the substrate. When topcoat is present on the substrate, the topcoat is said to have excellent adhesion to the substrate. Adhesion to the substrate may depend on several factors, including whether the substrate is corona treated, whether a chemical and/or mechanical bond forms between the topcoat and the substrate, whether the chemical bond is ionic, covalent, or a hydrogen bond, how the topcoat is dried, and the coat weight of the topcoat.

Additionally, adherence of low migration inks to the topcoat has been problematic in the art. Low migration inks are commonly used in food packaging applications for both direct and indirect food contact. Ink migration may occur by penetration of the ink through a substrate, by set-off transfer, or by migration via vapor phase transfer. Generally, an ink is a low migration ink if it complies with the so called “10 ppb” rule, e.g., specific migration of the ink does not exceed 10 ppb. As used herein, a conventional ink is an ink having a migration of greater than 10 ppb as measured by passing 10 g/m ink on a polyester foil under a standard mercury lamp at a speed of 20 m/minute and extracting 1 dm² of the sample with ethanol (95% vol %) for 24 hours at room temperature. As used herein, a low migration ink is an ink having a migration of less than 10 ppb, measured as described above. Migration may be caused by unreacted residual components in the ink, as well as the use of photoinitiators. In generally, low migration inks have more active defoamers than conventional inks, use a more limited choice of monomers than conventional inks, have a greater cross-linking density than convention inks, and have an absence of low molecular weight components (those under 1000 D) than conventional inks Adhesion of the ink to the topcoat may be measured using the same 3M 810 and 610 tape test described above, except that the topcoat is viewed using infrared spectroscopy to check for the presence of ink on the topcoat. If topcoat is present on the film, there are different peaks visible using infrared spectroscopy whereas if the topcoat is removed during the tape test, then only the substrate peak is visible using infrared spectroscopy.

The topcoat described herein, comprising an optionally crosslinked cationic acrylic polymer, has excellent adhesion to the substrate and excellent ink anchorage for conventional inks and low migration inks. In some aspects, the average ink anchorage is at least 70% immediately after drying the topcoat onto the substrate, e.g., at least 80%, at least 90%, 92.5%, at least 95%, or at least 97%. In some aspects, the ink anchorage is at least 85% 24 hours after drying the topcoat onto the substrate, e.g., at least 90%, at least 92.5%, at least 95%, or at least 97%. This ink anchorage may be achieved for both convention and low migration inks. In some aspects, the ink anchorage may be as great as 100% immediately after drying the topcoat onto the substrate and applying conventional or low migration inks. The ink may be printed onto the substrate using a flexo machine at varied speeds, e.g., speeds of 80 mpm, 100 mpm, or 150 mpm. In some aspects, the ink may be printed using cold foil, e.g., at a cold foil speed of 60 mpm or 80 mpm. Varied ink colors may be used, including white, cyan, magenta, yellow, and black, at varied lines per inch and cell volume loadings. Regardless of ink type, print speed, or printing type, the topcoats described herein had excellent ink anchorage.

### Topcoat Components

As described herein the topcoat is formed by optionally crosslinking a cationic acrylic polymer. In some aspects, when crosslinked, the cationic acrylic polymer is crosslinked in solution, e.g., in the presence of water. In these aspects, the topcoat is a water-based topcoat formed from a solution comprising a cationic acrylic polymer, a crosslinker, and water. Regardless of crosslinking, the solution may have a pH of at least 4, e.g., at least 4.25, at least 4.5, or at least 4.75. In terms of upper limits, the solution may have a pH of less than 7, e.g., less than 6.75, less than 6.5, less than 6.25, or less than 6. In terms of ranges, the solution may have a pH from 4 to 7, e.g., from 4.25 to 6.75, from 4.5 to 6.5, from 4.75 to 6.25, or from 4.75 to 6. The solids content of the solution may be at least 25%, e.g., at least 27.5%, at least 30%, or at least 35%. In terms of upper limits, the solids content of the solution may be less than 55%, e.g., less than 50%, less than 47.5%, or less than 45%. In terms of ranges the solids content of the solution may range from 25 to 55%, e.g., from 27.5 to 50%, from 30 to 47.5%, or from 35 to 45%. The solution may also comprise further components as described herein, including a crosslinker.

In terms of lower limits, the solution may comprise at least 10 parts by weight of a cationic acrylic polymer, based on a total of 100 parts by weight, e.g., at least 20 parts by weight, at least 30 parts by weight, at least 40 parts by weight, or at least 50 parts by weight. In terms of upper limits, the solution may comprise less than 98.5 parts by weight of a cationic acrylic polymer, based on a total of 100 parts by weight, e.g., less than 90 parts by weight, less than 80 parts by weight, or less than 70 parts by weight. In terms of ranges, the solution may comprise from 10 to 98.5 parts by weight of a cationic acrylic polymer, based on a total of 100 parts by weight, e.g., from 20 to 90 parts by weight, from 30 to 80 parts by weight or from 50 to 70 parts by weight.

A “cationic acrylic polymer” refers to acrylic polymers that comprise cationic functional groups that impart a positive charge. The cationic acrylic polymer can be formed by any means known in that art. The cationic acrylic polymer may be crosslinkable or non-crosslinkable. Suitable cationic acrylic polymers include, for example, copolymers of one or more alkyl esters of acrylic acid or methacrylic acid, optionally together with one or more other polymerizable ethylenically unsaturated monomers. Suitable alkyl esters of acrylic acid or methacrylic acid include, without limitation, methyl methacrylate, ethyl methacrylate, butyl methacrylate, ethyl acrylate, butyl acrylate, and 2-ethyl hexyl acrylate. Suitable other copolymerizable ethylenically unsaturated monomers include nitriles, such as acrylonitrile and methacrylonitrile, vinyl and vinylidene halides, such as vinyl chloride and vinylidene fluoride, and vinyl esters, such as vinyl acetate, among other monomers. Acid and anhydride functional ethylenically unsaturated monomers, such as acrylic acid, methacrylic acid or anhydride, itaconic acid, maleic acid or anhydride, or fumaric acid may be used. Amide functional monomers including, without limitation, acrylamide, methacrylamide, and N-alkyl substituted (meth)acrylamides are also suitable. Vinyl aromatic compounds, such as styrene and vinyl toluene, can also be used in certain cases.

Functional groups, such as hydroxyl and amino groups, can be incorporated into the acrylic polymer by using functional monomers, such as hydroxyalkyl acrylates and methacrylates or aminoalkyl acrylates and methacrylates. Epoxide functional groups (for conversion to cationic salt groups) may be incorporated into the acrylic polymer by using functional monomers, such as glycidyl acrylate and methacrylate, 3,4-epoxycyclohexyl methyl (meth)acrylate, 2-(3,4-epoxycyclohexyl)ethyl(meth)acrylate, or ally! glycidyl ether. Alternatively, epoxide functional groups may be incorporated into the acrylic polymer by reacting carboxyl groups on the acrylic polymer with an epihalohydrin or dihalohydrin, such as epichlorohydrin or dichlorohydrin.

In some aspects, the cationic acrylic polymer is an aliphatic cationic acrylate, an aromatic cationic acrylate, an aliphatic cationic methacrylate, an aromatic cationic methacrylate, or combinations thereof. The cationic acrylic polymer may have hydroxyl functionality or may lack hydroxyl functionality. An exemplary cationic acrylic polymer is sold as Ottopol KX 63, sold by Gellner Industries, which is a mixture of high and low molecular weight polymer chains with a weight average molecular weight from 5 to 100 kDa. The cationic acrylic polymer may have hydroxyl functionality and may have a hydroxyl value from 65 to 80, e.g., from 67.5 to 77.5, or from 70 to 75. The cationic acrylic polymer may have an acid value from 6 to 14, e.g, from 8 to 12 or from 9 to 11. The pH of the cationic acrylic polymer may be acidic, e.g., from 5 to 6.9 or from 5.5 to 6. The viscosity of the cationic acrylic polymer may range from about 500 to about 800 cps with a solids content from 38 to 40%.

The cationic acrylic polymer may have a glass transition temperature (Tg) of at least −10° C., e.g., at least −5° C. , at least 0° C., or at least 5° C. In terms of upper limits, the cationic acrylic polymer may have a Tg of less than 30° C., e.g., less than 25° C., less than 20° C., or less than 15° C. In terms of ranges, the cationic acrylic polymer may have a Tg from −10 to 30° C., e.g., from −10 to 25° C., from −10 to 20° C., from −10 to 15° C., from −5 to 25° C., from 0 to 20° C., or from 5 to 15° C.

In some aspects, the topcoat comprises a crosslinked cationic acrylic polymer. As described above, the crosslinker is added to the cationic acrylic polymer prior to drying the topcoat, typically in solution. The crosslinker may be included in an amount from 1.5 to 10%, based on the total solids of the cationic acrylic polymer (e.g., in the absence of water), e.g., from 2 to 8% or from 2.5 to 7.5%. The crosslinker may comprise a dispersible formulation of polyfunctional aziridines, isocyanates, melamine resins, epoxies, oxazolines, carbodiimides and other multifunctional crosslinkers. In some aspects, the crosslinker may be an epoxy resin, such as a multifunctional epoxy resin. Exemplary resins include epoxidized sorbitol (for example, sold as ERISYS® 60B and ERISYS® GE-60, sorbitol polyglycidyl ether (for example, sold as DENACOL® Ex-614B). Without being bound by theory, the epoxy resin is believed to crosslink the acrylic resins in the cationic acrylic polymer to provide for improved chemical resistance in light stable coatings.

In some aspects, the solution comprises a surfactant. In terms of lower limits, the solution may comprise at least 0.001 parts by weight surfactant, based on a total of 100 parts by weight, e.g., at least 0.01 parts by weight, or at least 0.025 parts by weight. In terms of upper limits, the solution may comprise at most 3 parts by weight surfactant, based on a total of 100 parts by weight, e.g., at most 1 parts by weight or at most 0.075 parts by weight. In terms of ranges, the solution may comprise from 0.001 to 3 parts by weight surfactant, based on a total of 100 parts by weight, e.g., from 0.01 to 1 parts by weight or from 0.025 to 0.075 parts by weight.

The surfactant may be a cationic surfactant or a nonionic surfactant. Non-limiting examples of nonionic surfactants include alkylphenol ethoxylates, such as nonylphenol ethoxylate, and Disponil A 3065, an ethoxylated nonionic surfactant available from Henkel of America Inc. (King of Prussia, Pa.). Examples of nonionic surfactants include TRITON X-100, TRITON X-102, TRITON X-114, TRITON X-101, and TRITON CF-10 surfactants (all available from Union Carbide Corp.); SURFYNOL CT-136 (which is actually a mixture of anionic and nonionic surfactants), SURFYNOL 104, SURFYNOL 465, and SURFYNOL TG surfactants (all available from Air Products and Chemicals of Allentown, Pa.); and Tergitol NP-9 and Tergitol NP-10 surfactants (both available from Union Carbide Chemicals and Plastics Co. of Danbury, Conn.). Surfynol 104 DPM is particularly useful because it also act to control foaming. A non-limiting example of a cationic surfactant useful in the practice of the invention is hexadecyl trimethylammonium chloride (HDTMAC), available from Akzo Nobel Chemicals Inc. (Chicago, Ill.).

In terms of lower limits, the solution may comprise at least 10 parts by weight water, based on a total of 100 parts by weight, e.g., at least 20 parts by weight or at least 30 parts by weight. In terms of upper limits, the solution may comprise less than 60 parts by weight water, based on a total of 100 parts by weight, e.g., less than 55 parts by weight, or less than 50 parts by weight. In terms of ranges, the solution may comprise from 10 to 60 parts by weight water, based on a total of 100 parts by weight, e.g., from 20 to 55 parts by weight, or from 30 to 50 parts by weight. The water may be distilled water.

In some aspects, the solution comprises a binder. In terms of lower limits, the solution may comprise at least 0.1 parts by weight of a binder, based on a total of 100 parts by weight, e.g., at least 1 part by weight or at least 3 parts by weight. In terms of upper limits, the solution may comprise less than 30 parts by weight of a binder, based on a total of 100 parts by weight, e.g., less than 20 parts by weight, or less than 10 parts by weight. In terms of ranges, the solution may comprise from 0.1 to 30 parts by weight of a binder, based on a total of 100 parts by weight, e.g., from 1 to 20 parts by weight, or from 3 to 10 parts by weight.

The binder may be included in the solution to help stabilize the solution once it is coated onto a substrate. The binder may also improve cohesion and mechanical integrity of the solution. The binder is typically are water-soluble or water-dispersible, especially when the ultimate application is aqueous-based ink jet printing, and include, for example, those selected from the group consisting of polyvinyl alcohols (PVAs); modified polyvinyl alcohols (e.g., carboxyl-modified PVA, silicone-modified PVA, maleic acid-modified PVA, and itaconic acid-modified PVA); polysaccharides; polyurethane dispersions; acrylic copolymers; vinyl acetate copolymers; poly(vinyl pyrrolidone); vinyl pyrrolidone copolymers; poly(2-ethyl-2-oxazoline); poly(ethylene oxide); poly(ethylene glycol); poly(acrylic acids); starch; modified starch (e.g., oxidized starch, cationic starch, hydroxypropyl starch, and hydroxyethyl starch), cellulosic polymers oxidized cellulose, cellulose ethers, cellulose esters, methyl cellulose, hydroxyethyl cellulose, carboxymethyl-cellulose, benzyl cellulose, phenyl cellulose, hydroxypropyl cellulose, ethyl hydroxyethyl cellulose, hydroxyethyl methyl cellulose, hydroxypropyl methyl cellulose, hydroxy butylmethyl cellulose, dihydroxypropyl cellulose, hydroxypropyl hydroxyethyl cellulose, chlorodeoxycellulose, aminodeoxycellulose, diethylammonium chloride hydroxyethyl cellulose, and hydroxypropyl trimethyl ammonium chloride hydroxyethyl cellulose); alginates and water-soluble gums; dextrans; carrageenan; xanthan; chitosan; proteins; gelatins; agar; and mixtures thereof. In some aspects, the binder is poly(vinyl pyrrolidone). In further aspects, the binder is a polyvinyl pyrrolidone/vinyl acetate copolymer (PVP/VA). The PVP/VA may have a weight ratio of vinyl pyrrolidone to vinyl acetate from 50:50 to 80:20 vinyl pyrrolidone to vinyl acetate, e.g., from 50:50 to 75:25. In some aspects, the weight ratio is 60:40 vinyl pyrrolidone to vinyl acetate. The PVP/VA may be a linear random copolymer. The PVP/VA may have a Tg of 90 to 115° C., e.g., from 95 to 110° C. or from 100 to 110° C.

In some aspects, the solution may further comprise at least one wax, such as a cationic wax. In terms of lower limits, the solution may comprise at least 0.1 parts by weight wax, based on a total of 100 parts by weight, e.g., at least 0.5 parts by weight or at least 1 part by weight. In terms of upper limits, the solution may comprise less than 15 parts by weight wax, based on a total of 100 parts by weight, e.g., less than 10 parts by weight, or less than 5 parts by weight. In terms of ranges, the solution may comprise from 0.1 to 15 parts by weight wax, based on a total of 100 parts by weight, e.g., from 0.5 to 10 parts by weight, or from 1 to 5 parts by weight.

When included, the wax helps improve scratch resistance. In one embodiment, the particles in the wax are less than 5, or less than 0.5 microns in size. The melting point of the wax or of the mixture of waxes preferably ranges from 50 to 150° C. In addition, the particles in the microdispersion can contain a small amount of oily or pasty fatty additives, one or more surfactants and one or more common liposoluble active ingredients. The waxes include natural (animal or plant) or synthetic substances which are solid at room temperature (20-25° C.). In one embodiment, they are insoluble in water, soluble in oils and are capable of forming a water-repellent film. A definition of waxes is provided by, for example, P. D. Dorgan, Drug and Cosmetic Industry, December 1983, pp. 30-33. The wax(es) includes carnauba wax, candelilla wax and alfalfa wax, and mixtures thereof.

In addition to these waxes, the mixture of waxes can also contain one or more of the following waxes or family of waxes: paraffin wax, ozokerite, plant waxes, such as olive wax, rice wax, hydrogenated jojoba wax or the absolute waxes of flowers, such as the essential wax of blackcurrant flower sold by the company Bertin (France), animal waxes, such as beeswaxes or modified beeswaxes (cerabellina); other waxes or waxy starting materials; marine waxes, such as those sold by the company Sophim under the identifier M82; natural or synthetic ceramides, and polyethylene or polyolefin waxes in general. The carnauba (extract of Copernica cerifera), candelilla (extract of Euphorbia cerifera and of Pedilantus pavonis) and alfalfa (extract of Stipa tenacissima) plant waxes are commercial products. Examples of commercially available waxes are Aquacer 499, 520, 537, 608 available from Byk Cera. In some aspects, the wax may be a cationic wax, such as a cationic high density polyethylene wax.

The solution may further comprise at least one additive, also referred to as an additive package. In terms of lower limits, the solution may comprise at least 0.01 parts by weight of at least one additive, based on a total of 100 parts by weight, e.g., at least 0.05 parts by weight or at least 0.1 part by weight. In terms of upper limits, the solution may comprise less than 5 parts by weight of at least one additive, based on a total of 100 parts by weight, e.g., less than 1 parts by weight, or less than 0.5 parts by weight. In terms of ranges, the solution may comprise from 0.01 to 5 parts by weight of at least one additive, based on a total of 100 parts by weight, e.g., from 0.05 to 1 part by weight, or from 0.1 to 0.5 parts by weight.

The at least one additive may be selected from the group consisting of waxes (in addition to the cationic wax disclosed herein), defoamers, anti-oxidants, UV stabilizers, fillers, anti-blocking agents and combinations thereof. In some aspects, the solution comprises at least two additives, e.g., at least three additives or at least four additives. In further aspects, the solution comprises a wax, a defoamer, and a filler as additives. In some aspects, a second wax and a filler may be included. The combination of these fillers may improve scuff and scratch resistance, as well as blocking and print receptivity, especially when a water-based print is used.

A second wax, in addition to the above described wax, may be included. The second wax may be a wax as described above, though different from the first wax. In some aspects, a non-ionic wax, such as a polyethylene terephthalate wax may be used.

When included, a defoaming agent generally reduces or mitigates the formation of foaming in the solution layer when deposited or generally handled or transferred from one location to another. Generally, any defoaming agent that does not interfere in some embodiments, desired loadings and/or physical or mechanical properties of the solution layer may be used. For instance, the defoaming agent may be mineral-based, silicone-based, or non-silicone-based.

Any suitable antioxidants for a particular embodiment may be used. In some embodiments, antioxidants may be selected that exhibit good heat resistance and mitigate the discoloration of polymeric-based articles/coatings. Exemplary antioxidants suitable for use according to certain embodiments of the present invention include, but not limited to, CHINOX 626, CHINOX 62S (organophophite antioxidant), CHINOX 245 (steric hindered phenolic antioxidant), and CHINOX 30N (blend of hindered phenolic antioxidants), each of which is commercially available from Double Bond Chemical Ind., Co., Ltd.

UV stabilizers include, but are not limited to hindered amine absorbers available from Ciba-Geigy under the trade designation Tinuvin, especially those available under the designations Tinuvin 234, Tinuvin 326, Tinuvin 327 and Tinuvin 328. The light stabilizers that can be used include the hindered amine light stabilizers available from Ciba-Geigy under the trade designations Tinuvin 111, Tinuvin 123, Tinuvin 622, Tinuvin 770 and Tinuvin 783. Also useful light stabilizers are the hindered amine light stabilizers available from Ciba-Geigy under the trade designation Chimassorb, especially Chimassorb 119 and Chimassorb 944.

Fillers include, but are not limited to metal oxides, talc, calcium carbonate, organo-clay, glass fibers, marble dust, cement dust, feldspar, silica or glass, fumed silica, silicates, alumina, various phosphorus compounds, ammonium bromide, titanium dioxide, antimony trioxide, antimony trioxide, zinc oxide, zinc borate, barium sulfate, silicones, aluminum silicate, calcium silicate, glass microspheres, chalk, mica, clays, wollastonite, ammonium octamolybdate, intumescent compounds and mixtures of two or more of these materials. The fillers may also carry or contain various surface coatings or treatments, such as silanes, fatty acids, and the like. Still other fillers can include flame retardants, such as the halogenated organic compounds. In certain embodiments, the solution layer may include one or more thermoplastic elastomers that are compatible with the other constituents of the layer, such as etherified melamine, hydroxylated polyester, polyester-melamine, and other suitable elastomers.

The additive may be an anti-blocking additive. These additives reduce the tendency of the film to stick together when it is in roll form. The anti-blocking additives include natural silica, diatomaceous earth, synthetic silica, glass spheres, ceramic particles, etc. Slip additives including primary amides such as stearamide, behenamide, oleamide, erucamide, and the like; secondary amides such as stearyl erucamide, erucyl erucamide, oleyl palimitamide, stearyl stearamide, erucyl stearamide, and the like; ethylene bisamides such as N, NN-ethylenebisstearamide, N, NN-ethylenebisolamide and the like; and combinations of any two or more of the foregoing amides can also be included.

Anti-freeze additives to protect the material from freezing may be included, as well as modified non-ionic polymeric compounds, modified quaternary ammonium polymeric compounds, and cationic salts. When included, these additive may be included from 0.01 to 1 part by weight, based on a total weight of 100, depending on requirements for performance and processing.

### Solution Preparation

The solution preparation depends on the components included. In embodiments where the solution includes a surfactant, the surfactant may first be combined with water and stirred. The binder may then be added to the water and surfactant mixture, and mixed. The binder may be added slowly under high agitation, e.g., from 500 to 1000 rpm. Mixing may occur in the presence of nitrogen purging or under vacuum to avoid microbubble formation during solution formation. The solution may then be allowed to settle, allowing for removal of any air bubbles. The solids content of the mixture may be calculated at this point. If needed, the solids content may be adjusted. Mixing may then restart. The speeds of mixing may be from 500 to 600 rpm. Next, the cationic acrylic polymer and optional crosslinker are added to the mixture. When included, a wax may be added and the entire mixture may be stirred. If included, additives may then be added.

### Topcoat

As described above, the solution may be coated, e.g., onto a substrate, as a topcoat. When coated as a topcoat, the water from the solution is evaporated. When included, the surfactant may also be evaporated when the topcoat is dried. Therefore, the components of the topcoat, e.g., at a minimum, the cationic acrylic polymer and the optional crosslinker may be present in different weight percentages as compared to the solution. Once coated onto a substrate, the surface energy of the topcoat may be at least 28 mN/m, e.g., at least 30 mN/m, or at least 30 mN/m. In terms of ranges, the surface energy may be from 25 to 60 mN/m, e.g., from 28 to 60 mN/m or from 30 to 60 mN/m.

In terms of lower limits, the topcoat may comprise at least 70 parts by weight of an optionally crosslinked cationic acrylic polymer, based on a total of 100 parts by weight, e.g., at least 75 parts by weight, at least 80 parts by weight, at least 85 parts by weight, or at least 90 parts by weight. In terms of upper limits, the topcoat may comprise less than 98.5 parts by weight of an optionally crosslinked cationic acrylic polymer, based on a total of 100 parts by weight, e.g., less than 97.5 parts by weight, less than 95 parts by weight, or less than 92.5 parts by weight. In terms of ranges, the topcoat may comprise from 70 to 98.5 parts by weight of an optionally crosslinked cationic acrylic polymer, based on a total of 100 parts by weight, e.g., from 75 to 97.5 parts by weight, from 80 to 95 parts by weight, from 85 to 95 parts by weight, from 85 to 92.5 parts by weight, or from 90 to 92.5 parts by weight.

In terms of lower limits, the topcoat may comprise at least 0.005 parts by weight surfactant, based on a total of 100 parts by weight, e.g., at least 0.02 parts by weight, or at least 0.03 parts by weight. In terms of upper limits, the topcoat may comprise at most 3 parts by weight surfactant, based on a total of 100 parts by weight, e.g., at most 1 parts by weight or at most 0.09 parts by weight. In terms of ranges, the topcoat may comprise from 0.005 to 3 parts by weight surfactant, based on a total of 100 parts by weight, e.g., from 0.02 to 1 parts by weight or from 0.03 to 0.9 parts by weight.

In some aspects, in terms of lower limits, the topcoat may comprise at least 0.1 parts by weight of a binder, based on a total of 100 parts by weight, e.g., at least 3 part by weight or at least 5 parts by weight. In terms of upper limits, the topcoat may comprise less than 40 parts by weight of a binder, based on a total of 100 parts by weight, e.g., less than 30 parts by weight, or less than 15 parts by weight. In terms of ranges, the topcoat may comprise from 0.1 to 40 parts by weight of a binder, based on a total of 100 parts by weight, e.g., from 3 to 30 parts by weight, or from 5 to 15 parts by weight.

In some aspects, the topcoat may further comprise at least one wax, such as a cationic wax. In terms of lower limits, the topcoat may comprise at least 0.1 parts by weight wax, based on a total of 100 parts by weight, e.g., at least 2 parts by weight or at least 3 parts by weight. In terms of upper limits, the topcoat may comprise less than 20 parts by weight wax, based on a total of 100 parts by weight, e.g., less than 15 parts by weight, or less than 10 parts by weight. In terms of ranges, the topcoat may comprise from 0.1 to 20 parts by weight wax, based on a total of 100 parts by weight, e.g., from 2 to 15 parts by weight, or from 3 to 10 parts by weight.

In some aspects, the topcoat may further comprise at least one additive. In terms of lower limits, the topcoat may comprise at least 0.01 parts by weight of at least one additive, based on a total of 100 parts by weight, e.g., at least 0.1 parts by weight or at least 0.3 parts by weight. In terms of upper limits, the topcoat may comprise less than 10 parts by weight of at least one additive, based on a total of 100 parts by weight, e.g., less than 5 parts by weight, or less than 1 part by weight. In terms of ranges, the topcoat may comprise from 0.01 to 10 parts by weight of at least one additive, based on a total of 100 parts by weight, e.g., from 0.1 to 5 parts by weight, or from 0.3 to 1 parts by weight.

The coat weight of the topcoat may vary, but is generally within the range from 0.1 to 1.5 grams per square meter (“gsm”), e.g., from 0.1 to 1.25 gsm or from 0.25 to 1 gsm. The substrate is generally a film (such as a polymer described herein), a label, paper, or a metal foil.

In some aspects, the topcoat is coated onto a label, which generally comprises a facestock layer. The facestock layer may be a polymer layer as described herein, such as a polyvinyl chloride or polyolefin film that is directly adjacent to the topcoat. The polyolefin film has top and bottom surfaces. From the perspective looking downwardly toward the substrate, the polyolefin film may be configured beneath the topcoat, e.g., the top surface of the polyolefin film is adjacent the topcoat. In some aspects, the polymer film is polyethylene, polypropylene (including biaxially oriented polypropylene (BOPP)), or polyethylene terephthalate. In some aspects, a crosslinker is not included when the facestock layer comprises polyethylene, polyethylene terephthalate, and/or polypropylene. In other aspects, a crosslinker is included when the facestock layer comprises polypropylene.

The polyolefin film may vary widely. In some embodiments, the polyolefin film may comprise any polyolefin material that exhibits good mechanical strength and heat resistance. Exemplary polyolefin films may comprise at least one of a polyimide, a polyester, a polyetherimide (PEI), a polyethylene naphthalate (PEN), a polyether sulfone (PES), a polysulfone, polymethylpentene (PMP), a polyvinylidene fluoride (PVDF), an ethylene-chlorotrifluoroethylene (ECTFE), or combinations thereof. In certain embodiments, especially when the label may be used at high temperatures, the polyolefin film comprises at least one polyimide.

Exemplary polyolefin films made of polyimide include Kapton®, available from DuPont, and Apical©, available from Kaneka Texas Corporation, Exemplary polyolefin films made of polyester include Mylar©, available from DuPont, and 2600 polyethylene terephthalate film, available from American Hoechst. Other commercially available polyolefin films include Tempalux™ (PEI), available from Westlake Plastics Company; Superio-UT™ (PEI), available from Mitsubishi Plastics, Kaladex™; (PEN) and Teonex (PEN), both available from DuPont.

The polyolefin films according to certain embodiments of the present invention may comprise a thickness ranging from 1 to 400 microns, e.g., from 10 to 300 microns, from 25 to 200 microns, or from 50 to 150 microns, and other ranges in the foregoing amounts. In terms of lower limits, the polyolefin films may have a thickness of at least 1 micron, e.g., at least 10 microns, at least 25, or at least 50 microns and may exceed 300 microns. In terms of upper limits, the polyolefin films may have a thickness less than 400 microns, e.g., less than 300 microns, less than 200 microns, or less than 150 microns.

In some aspects, the label may further comprise a primer layer. The primer layer may be directly adjacent to the polyolefin film on the opposite surface of the polyolefin film from the topcoat, e.g., the polyolefin film may be configured between the topcoat and the primer layer. The primer layer may comprise a crosslinker and optionally may include additives as disclosed for the topcoat. The primer layer may be coated onto the polyolefin film by gravure. After curing at a temperature from about 150 to 180° C., the primer is affixed to the film. Additionally, when crosslinker is included in the primer layer, the hydroxyl group on the polyolefin film with react with the crosslinker and thus the primer layer is chemically bonded to the polyolefin film.

The thickness of the primer layer may range from 0.01 to 50 microns, e.g., from 0.1 to 25 microns, or from 0.5 to 10 microns. In terms of lower limits, the primer layer may have a thickness of at least 0.01 micron, e.g., at least 0.1 microns, or at least 0.5 micros. In terms of upper limits, the primer layer may have a thickness less than 50 microns, e.g., less than 25 microns, or less than 10 microns.

The label may further comprise an adhesive layer. The adhesive layer may comprise any adhesive that is effective in binding the label to an external surface of the substrate to which the label may be affixed. In some aspects, the adhesive may be a pressure sensitive adhesive. An aggressive pressure sensitive adhesive may be used, such as one of the high-strength or rubber- modified acrylic pressure sensitive adhesives, such as Duro-Tak® 80-115 A available from National Starch and Chemical Co. or Aroset™ 1860-Z-45 available from Ashland Specialty Chemical Company. Suitable pressure sensitive adhesives may include, for example, copolymers of alkyl acrylates that have a straight chain of from 4 to 12 carbon atoms and a minor proportion of a highly polar copolymerizable monomer such as acrylic acid. These adhesives are more fully described in U.S. Pat. Re. 24,906 and U.S. Pat. No. 2,973,286, the contents of each are hereby incorporated by reference in their entirety. Alternative pressure sensitive adhesives include ultraviolet curable pressure sensitive adhesives, such as Duro-Tak 4000, which is available from National Starch and Chemical Co.

The label may further comprise a releasable liner. The releasable liner may be positioned directly adjacent to the adhesive layer, on the opposite side of the adhesive layer from the primer layer. In this regard, the releasable liner may protect the adhesive layer before the label is applied (or intended to be applied) to an object or facestock, such as during manufacture, printing, shipping, storage, and at other times. Any suitable material for a releasable liner may be used. Typical and commercially available releasable liners, which can be suitable for embodiments of the present invention, can include a silicone-treated release paper or film, such as those available from Loparex, including products such as 1011, 22533 and 1 1404, CP Films, and Akrosil™.

Each of the layers of the label may also contain additives in amounts as described herein, including antioxidants and cross-linkers.

In further embodiments, the solution may be coated onto paper, such as cast gloss paper. The topcoat disclosed herein beneficially exhibits good adhesion to cast gloss paper. The coat weight of the topcoat may vary, but is generally within the range from 0.1 to 1.5 grams per square meter (“gsm”), e.g., from 0.1 to 1.25 gsm or from 0.25 to 1 gsm. The coat weight of the topcoat may be adjusted if a specific range for the coat weight or solids content is desired. Generally, a greater coat weight and solids content are desired for a topcoat coated onto paper as compared to a topcoat coated onto a polyolefin film.

The following embodiments are contemplated. All combinations of features and embodiments are contemplated.

Embodiment 1: A topcoat solution consisting essentially of: a cationic acrylic polymer and an optional crosslinker, wherein when present, the crosslinker is present in an amount of at least 1.5%, based on the total weight of the topcoat solution.

Embodiment 2: An embodiment of embodiment 1, wherein the cationic acrylic polymer is present in an amount from 10 to 98.5 parts by weight, based on a total of 100 parts by weight.

Embodiment 3: An embodiment of any one of the embodiments of embodiments 1-2, wherein the cationic acrylic polymer comprises an aliphatic cationic acrylate, an aromatic cationic acrylate, an aliphatic cationic methacrylate, an aromatic cationic methacrylate, or combinations thereof.

Embodiment 4: An embodiment of any one of the embodiments of embodiments 1-3, wherein the topcoat solution contains a single cationic acrylic polymer

Embodiment 5: An embodiment of any one of the embodiments of embodiments 1-3, wherein the crosslinker is present from 1.5 to 10 wt. %, based on a total of 100 parts by weight.

Embodiment 6: An embodiment of any one of the embodiments of embodiments 1-5, wherein the topcoat solution further comprises water.

Embodiment 7: An embodiment of embodiment 6, wherein the water is present from 0.1 to 75 wt. %.

Embodiment 8: An embodiment of any one of the embodiments of embodiments 1-7, wherein the cationic acrylic polymer is a cationic acrylic polymer dispersion.

Embodiment 9: An embodiment of embodiment 8, wherein the cationic acrylic dispersion has a solids content from 25 to 55%.

Embodiment 10: An embodiment of any one of the embodiments of embodiments 1-9, wherein the cationic acrylic polymer has a pH from 4 to 6.

Embodiment 11: An embodiment of any one of embodiments 1-10, wherein the crosslinker is an aziridine, isocyanate, or epoxy crosslinker.

Embodiment 12: An embodiment of any one of the embodiments of embodiments 1-11, wherein the cationic acrylic polymer has hydroxyl functionality.

Embodiment 13: A coated substrate comprising: (a) a substrate and (b) a topcoat formed from the topcoat solution according to any of embodiments 1-12.

Embodiment 14: An embodiment of embodiment 13, wherein the substrate is a paper or a film.

Embodiment 15: An embodiment of any one of embodiments 13-14, further comprising an ink printed onto the topcoat.

Embodiment 16: An embodiment of embodiment 15, wherein the ink is a conventional ink.

Embodiment 17: An embodiment of any one of embodiments 13-16, wherein the topcoat is coated onto the substrate in a coat weight from 0.1 gsm to 1.5 gsm.

Embodiment 18: A label comprising: (a) a substrate; and (b) a topcoat formed from the topcoat solution according to any embodiments 1-12, wherein the topcoat is in contact with the substrate.

Embodiment 19: An embodiment of embodiment 18, wherein the topcoat is coated onto the label in a coat weight from 0.1 to 1.5 gsm.

Embodiment 20: An embodiment of any one of the embodiments of embodiments 18-19, wherein the substrate comprises a film and wherein a top surface of the film is in contact with the topcoat.

Embodiment 21: An embodiment of embodiment 20, wherein the film comprises biaxially oriented polypropylene (BOPP), polyethylene terephthalate (PET), polyethylene (PE), and/or polyvinyl chloride (PVC).

Embodiment 22: An embodiment of any one of the embodiments of embodiments 20-21, wherein the substrate further comprises an adhesive layer, wherein a top surface of the adhesive layer is in contact with a bottom surface of the film.

Embodiment 23: An embodiment of embodiment 22, wherein the substrate further comprises a release liner in contact with a bottom surface of the adhesive layer.

Embodiment 24: An embodiment of embodiment 23, wherein the adhesive layer comprises a pressure sensitive adhesive.

Embodiment 25: A method of forming a topcoat comprising: (i) providing a cationic acrylic polymer and an optional crosslinker; (ii) optionally crosslinking the cationic acrylic polymer, (iii) coating the cationic acrylic polymer onto a substrate; and (vii) drying the topcoat on the substrate to form a coated substrate.

Embodiment 26: An embodiment of embodiment 26, wherein the cationic acrylic polymer is present in an amount from 10 to 98.5 parts by weight, based on a total of 100 parts by weight of the components in (i).

Embodiment 27: An embodiment of any one of the embodiments of embodiments 25-26, wherein the cationic acrylic polymer comprises an aliphatic cationic acrylate, an aromatic cationic acrylate, an aliphatic cationic methacrylate, an aromatic cationic methacrylate, or combinations thereof.

Embodiment 28: An embodiment of any one of the embodiments of embodiments 25-27, wherein the topcoat solution contains a single cationic acrylic polymer

Embodiment 29: An embodiment of any one of the embodiments of embodiments 25-28, wherein the crosslinker is present from 1.5 to 10 wt. %, based on a total of 100 parts by weight of the components in (i).

Embodiment 30: An embodiment of any one of the embodiments of embodiments 25-29, wherein the cationic acrylic polymer is in a water solution

Embodiment 31: An embodiment of embodiment 30, wherein the water is present from 0.1 to 75 wt. %, based on the total weight of the cationic acrylic polymer, the water, and the crosslinker.

Embodiment 32: An embodiment of any one of the embodiments of embodiments 25-31, wherein the cationic acrylic polymer is a cationic acrylic polymer dispersion.

Embodiment 33: An embodiment of embodiment 32, wherein the cationic acrylic dispersion has a solids content from 25 to 55%.

Embodiment 34: An embodiment of any one of the embodiments of embodiments 25-33, wherein the cationic acrylic polymer has a pH from 4 to 6.

Embodiment 35: An embodiment of any one of embodiments 25-34, wherein the crosslinker is an aziridine, isocyanate, or epoxy crosslinker.

Embodiment 36: An embodiment of any one of the embodiments of embodiments 25-35, wherein the cationic acrylic polymer has hydroxyl functionality.

Embodiment 37: An embodiment of any one of the embodiments of embodiments 25-36, wherein when the substrate comprises polyethylene and/or polyethylene terephthalate, no crosslinker is used.

Embodiment 38: An embodiment of any one of the embodiments of embodiments 25-36, wherein when the substrate comprises polypropylene, crosslinker is used.

Embodiment 39: A coated substrate, wherein the substrate comprises polyethylene, polyethylene terephthalate, and/or polypropylene, and wherein the substrate is coated with a topcoat consisting essentially of cationic acrylic polymer.

Embodiment 40: A coated polypropylene substrate, wherein the substrate is coated with a topcoat consisting essentially of a crosslinked cationic acrylic polymer.

While the invention has been described in detail, modifications within the spirit and scope of the invention will be readily apparent to those of skill in the art. It should be understood that aspects of the invention and portions of various embodiments and various features recited herein and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

1. A topcoat solution consisting essentially of: a cationic acrylic polymer and an optional crosslinker, wherein when present, the crosslinker is present in an amount of at least 1.5%, based on the total weight of the topcoat solution.

2. The topcoat solution of claim 1, wherein the cationic acrylic polymer is present in an amount from 10 to 98.5 parts by weight, based on a total of 100 parts by weight.

3. The topcoat solution of claim 1, wherein the cationic acrylic polymer comprises an aliphatic cationic acrylate, an aromatic cationic acrylate, an aliphatic cationic methacrylate, an aromatic cationic methacrylate, or combinations thereof.

4. The topcoat solution of claim 1, wherein the topcoat solution contains a single cationic acrylic polymer

5. The topcoat solution of claim 1, wherein the crosslinker is present from 1.5 to 10 wt. %, based on a total of 100 parts by weight.

6. The topcoat solution of Ci wherein the topcoat solution further comprises water.

7. The topcoat solution of claim 6, wherein the water is present from 0.1 to 75 wt. %.

8. The topcoat solution of claim 1, wherein the cationic acrylic polymer is a cationic acrylic polymer dispersion.

9. The topcoat solution of claim 8, wherein the cationic acrylic dispersion has a solids content from 25 to 55%.

10. The topcoat solution of claim 1, wherein the cationic acrylic polymer has a pH from 4 to 6.

11. The topcoat solution of claim 1, wherein the crosslinker is an aziridine, isocyanate, or epoxy crosslinker.

12. The topcoat solution of claim 1, wherein the cationic acrylic polymer has hydroxyl functionality.

13. A coated substrate comprising: (a) a substrate and (b) a topcoat formed from the topcoat solution according to claim 1.

14. The coated substrate of claim 13, wherein the substrate is a paper or a film.

15. The coated substrate of claim 13, further comprising an ink printed onto the topcoat.

16. The coated substrate of claim 15, wherein the ink is a conventional ink.

17. The coated substrate of claim 13, wherein the topcoat is coated onto the substrate in a coat weight from 0.1 gsm to 1.5 gsm.

18. A label comprising: (a) a substrate; and (b) a topcoat formed from the topcoat solution according to claim 1, wherein the topcoat is in contact with the substrate.

19. The label of claim 18, wherein the topcoat is coated onto the label in a coat weight from 0.1 to 1.5 gsm.

20. The label of clam 18, wherein the substrate comprises a film and wherein a top surface of the film is in contact with the topcoat.

21. The label of claim 20, wherein the film comprises biaxially oriented polypropylene (BOPP), polyethylene terephthalate (PET), polyethylene (PE), and/or polyvinyl chloride (PVC).

22. The label of claim 20, wherein the substrate further comprises an adhesive layer, wherein a top surface of the adhesive layer is in contact with a bottom surface of the film.

23. The label of claim 22, wherein the substrate further comprises a release liner in contact with a bottom surface of the adhesive layer.

24. The label of claim 23, wherein the adhesive layer comprises a pressure sensitive adhesive.

25. A method of forming a topcoat comprising: (i) providing a cationic acrylic polymer and an optional crosslinker; (ii) optionally crosslinking the cationic acrylic polymer, (iii) coating the cationic acrylic polymer onto a substrate; and (vii) drying the topcoat on the substrate to form a coated substrate.

26. The method of claim 25, wherein the cationic acrylic polymer is present in an amount from 10 to 98.5 parts by weight, based on a total of 100 parts by weight of the components in (i).

27. The method of claim 25, wherein the cationic acrylic polymer comprises an aliphatic cationic acrylate, an aromatic cationic acrylate, an aliphatic cationic methacrylate, an aromatic cationic methacrylate, or combinations thereof.

28. The method of claim 25, wherein the topcoat solution contains a single cationic acrylic polymer A

29. The method of claim 25, wherein the crosslinker is present from 1.5 to 10 wt. %, based on a total of 100 parts by weight of the components in (i).

30. The method of claim 25, wherein the cationic acrylic polymer is in a water solution.

31. The method of claim 30, wherein the water is present from 0.1 to 75 wt. %, based on the total weight of the cationic acrylic polymer, the water, and the crosslinker.

32. The method of claim 25, wherein the cationic acrylic polymer is a cationic acrylic polymer dispersion.

33. The method of claim 32, wherein the cationic acrylic dispersion has a solids content from 25 to 55%.

34. The method of claim 25, wherein the cationic acrylic polymer has a pH from 4 to 6.

35. The method of claim 25, wherein the crosslinker is an aziridine, isocyanate, or epoxy crosslinker.

36. The method of claim 25, wherein the cationic acrylic polymer has hydroxyl functionality.

37. The method of claim 25, wherein when the substrate comprises polyethylene and/or polyethylene terephthalate, no crosslinker is used.

38. The method of claim 25, wherein when the substrate comprises polypropylene, crosslinker is used.

39. A coated substrate, wherein the substrate comprises polyethylene, polyethylene terephthalate, and/or polypropylene, and wherein the substrate is coated with a topcoat consisting essentially of cationic acrylic polymer.

40. A coated polypropylene substrate, wherein the substrate is coated with a topcoat consisting essentially of a crosslinked cationic acrylic polymer.
